(19) United States
(12) Patent Application Publication
(10) Pub. No.: US 2026/0040362 A1
(43) Pub. Date: Feb. 5, 2026

(54) RANDOM ACCESS METHOD AND DEVICE, AND NON-TRANSITORY COMPUTER-READABLE STORAGE MEDIUM

(71) Applicant: SPREADTRUM SEMICONDUCTOR (NANJING) CO., LTD., Nanjing, Jiangsu (CN)

(72) Inventors: Zhenzhu LEI, Nanjing, Jiangsu (CN); Huayu ZHOU, Nanjing, Jiangsu (CN)

(21) Appl. No.: 18/996,435

(22) PCT Filed: Jul. 14, 2023
(86) PCT No.: PCT/CN2023/107429

§ 371 Date: Jan. 17, 2025

(30) Foreign Application Priority Data
Jul. 18, 2022 (CN) 202210842867.6

(51) Int. Cl. H04W 74/0833; H04W 72/21

(52) U.S. Cl. CPC H04W 74/0833; H04W 72/21

(57) ABSTRACT

A random access method and apparatus, and a computer-readable storage medium are provided. The random access method includes the following. when it is detected that a trigger condition is satisfied or a trigger indication is received, indication information is sent to a non-anchor network device; the indication information indicates that the non-anchor network device starts physical random access channel (PRACH) reception. A random access request message is sent to the non-anchor network device. By means of the solution, the static power consumption of the non-anchor network device can be effectively reduced.

### CROSS-REFERENCE TO RELATED APPLICATION(S)

This application is a National Stage of International Application No. PCT/CN2023/107429, field Jul. 14, 2023, which claims priority to Chinese Patent Application No. 202210842867.6, filed Jul. 18, 2022, the entire disclosure of both of which are hereby incorporated by reference.

### TECHNICAL FIELD

The present disclosure relates to the field of wireless communication technologies, and in particular, to a random access method and device, and a non-transitory computer-readable storage medium.

### BACKGROUND

With the further evolution of the 5G technology, improving the energy efficiency of the network becomes a current hot research topic. The power consumption of network devices accounts for a significant proportion of the power consumption of the network, and how to improve the energy efficiency of the network device is an urgent problem to be solved.

In a current network, in order to ensure user experience of a terminal device, a network device is usually in a working state or a semi-sleep state, and it is difficult to be completely shut down or enter a deep sleep mode. The power consumption of the network device mainly includes two parts: static power consumption and dynamic power consumption. The static power consumption mainly includes static receiving power consumption and static sending power consumption. The static receiving power consumption mainly includes receiving, by a network, a random access request message (Msg1) on a configured random access resource. The static sending power consumption mainly includes sending of a synchronization signal block (SSB), sending of a paging message, sending of system information, and the like.

In the related art, the static power consumption of the network device is high.

### SUMMARY

Embodiments of the present disclosure provide a random access method applied to a terminal device, and the method includes the following. In response to detecting that a trigger condition being satisfied or a trigger indication being received, indication information is sent to a non-anchor network device, where the indication information indicates that the non-anchor network device starts physical random access channel (PRACH) reception. A random access request message is sent to the non-anchor network device.

The embodiments of the present disclosure further provide a random access method applied to a non-anchor network device. The method includes the following. Indication information is received and PRACH reception is started. A random access request message is received.

The embodiments of the present disclosure further provide a random access device. The random access device includes a memory and a processor, the memory is configured to store a computer program executable on the processor, and the processor is configured to execute the computer program to perform any one of the random access methods described above.

### BRIEF DESCRIPTION OF THE DRAWINGS

FIG. 1 is a flowchart of a random access method provided in an embodiment of the present disclosure.

FIG. 2 is a schematic diagram of an existing communication scenario.

FIG. 3 is a flowchart of another random access method provided in an embodiment of the present disclosure.

FIG. 4 is a schematic structural diagram of a random access apparatus provided in an embodiment of the present disclosure.

FIG. 5 is a schematic structural diagram of another random access apparatus provided in an embodiment of the present disclosure.

FIG. 6 is a schematic structural diagram of a random access device provided in an embodiment of the present disclosure.

### DETAILED DESCRIPTION

Network energy saving (or, network power saving) is a problem concerned by mobile operators and equipment suppliers. Network energy saving is beneficial to reducing operation costs and protecting the environment. In a 5G network, because there are a lot of spectrum resources, for example, bands of 1 GHz, 2 GHZ, 4 GHZ, 6 GHZ, 26 GHz, etc., when the network load is relatively low, carriers or cells corresponding to certain bands (for example, 4 GHz, 6 GHZ or 26 GHZ) may be powered down and reactivated on demand, so as to achieve network energy saving.

That is to say, when the network load is relatively low, some carriers or cells do not need to carry data. Generally, network energy saving can be achieved by switching some carriers on and off, but this is typically feasible only when network load is low.

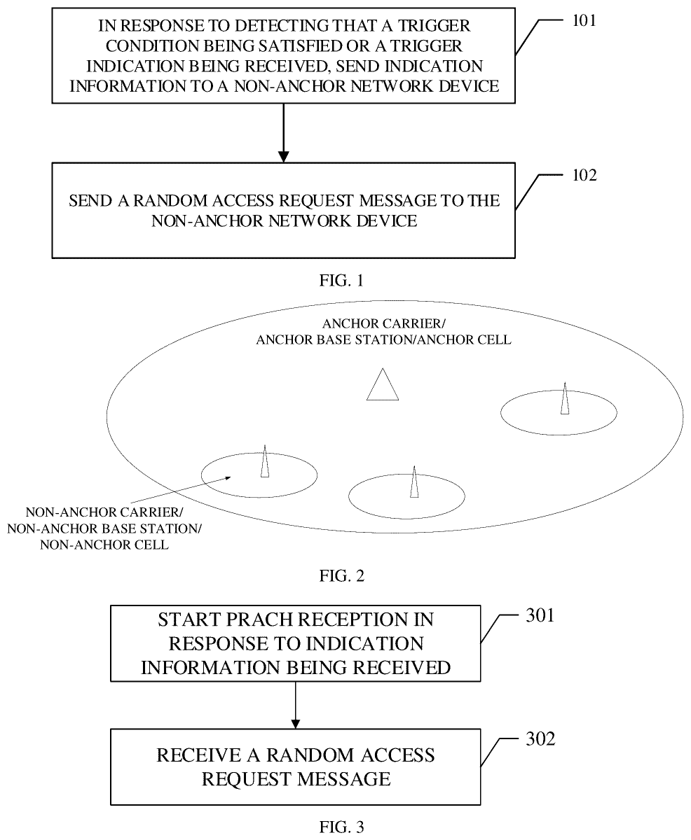

A carrier or cell capable of being switched on as needed may be referred to as a non-anchor carrier or non-anchor cell. In contrast, a carrier or cell that is unable to be switched off may be referred to as an anchor carrier or a non-anchor cell. Generally speaking, a non-anchor cell is deployed within a coverage area of an anchor cell. An anchor carrier provides a wide coverage, while a non-anchor carrier has a relatively small coverage area and provides a high-speed data transmission service. The non-anchor carrier is controlled by a network and can be switched on as required, as illustrated in FIG. 2. Referring to FIG. 2, a schematic diagram of an existing communication scenario is given. In FIG. 2, multiple non-anchor cells exist in a coverage area of an anchor cell.

In an existing communication system, a network device needs to constantly detect a random access request message (Msg1) sent by a terminal device in a configured physical random access channel (PRACH) occasion (RO), so as to ensure that the random access request message (Msg1) sent by the terminal device can be received in time. When the network load is low, the network device needs to detect Msg1 sent by the terminal device continuously in the configured RO, which results in high power consumption of the network device.

In embodiments of the present disclosure, when it is detected that a trigger condition is satisfied or a trigger indication is received, a terminal device sends indication information to a non-anchor network device. After receiving the indication information, the non-anchor network device starts PRACH reception, and then the terminal device sends a random access request message to the non-anchor network device, so as to access the non-anchor network device. Since the non-anchor network device does not start PRACH reception until receiving the indication information, the power consumption of the non-anchor network device can be reduced effectively.

To make objectives, features, and beneficial effects of the present disclosure clearer and more comprehensible, the following describes specific embodiments of the present disclosure in detail with reference to accompanying drawings.

Firstly, some terms involved in embodiments of the present disclosure are explained to facilitate understanding by a person skilled in the art.

### 1. Terminal Device

The terminal device in embodiments of the disclosure refers to a device with a wireless communication function and can be referred to as a terminal, a user equipment (UE), mobile station (MS), a mobile terminal (MT), an access terminal device, an in-vehicle terminal device, an industrial control terminal device, a UE unit, a UE station, a mobile station, a remote station, a remote terminal device, a mobile device, a UE terminal device, a wireless communication device, a UE agent, or a UE apparatus, etc. The terminal device can be fixed or mobile. It may be noted that the terminal device can support at least one type of wireless communication technology, such as long term evolution (LTE), new radio (NR), etc. For instance, the terminal device can be a mobile phone, a tablet (pad), a desktop computer, a laptop, an all-in-one, a vehicle terminal, a virtual reality (VR) terminal device, an augmented reality (AR) terminal device, a wireless terminal in industrial control, a wireless terminal in a self-driving vehicle, a wireless terminal in a remote medical surgery, a wireless terminal in smart grids, a wireless terminal in transportation safety, a wireless terminal in smart cities, a wireless terminal in smart homes, a cellular phone, a cordless phone, a session initiation protocol (SIP) phone, a wireless local loop (WLL) station, a personal digital assistant (PDA), a handheld device with a wireless communication function, a computing device, or other processing devices connected to a wireless modem, a wearable device, a terminal device in a future mobile communication network, or a terminal device in a future evolved public land mobile network (PLMN), and so on. In some embodiments of the disclosure, the terminal device may also be a device with transmit and receive functions, such as a chipset system, which may include a chip as well as other discrete components.

### 2. Network Device.

In embodiments of the disclosure, the network device is a device that provides wireless communication functions to terminals and can also be referred to as a radio access network (RAN) device, an access network element, etc. The network device can support at least one type of wireless communication technology such as LTE, NR, etc. For example, the network device includes but is not limited to: a generation nodeB (gNB), an evolved node B (cNB), a radio network controller (RNC), a node B (NB), a base station controller (BSC), a base transceiver station (BTS), a home base station (e.g., a home evolved node B, or a home node B (HNB)), a baseband unit (BBU), a transmitting and receiving point (TRP), a transmitting point (TP), a mobile switching center, and other devices in the 5th-generation (5G) mobile communication system. The Network device may also include a wireless controller, and a centralized unit (CU) and/or distributed unit (DU) in a cloud radio access network (CRAN) scenario, or the network device may be a relay station, an access point (AP), an in-vehicle device, a terminal device, a wearable device as well as an access network device in future mobile communications or an access network device in future evolved PLMN, etc. In some embodiments, the network device may also be a device that provides wireless communication functions to terminal devices, such as a chipset system, which may include a chip as well as other discrete components.

In some embodiments, the access network device can also communicate with an Internet Protocol (IP) network, such as the Internet, a private IP network, or other data networks.

Embodiment of the present disclosure provides a random access method, which will be described in detail through specific operations with reference to FIG. 1.

In an embodiment of the present disclosure, the random access method corresponding to operations at 101 and operations at 102 below may be executed by a chip with data processing capability in the terminal device, or may be executed by a chip module in the terminal device that includes the chip with data processing capability. For illustrative purpose, the terminal device is an execution body in the below.

At 101, When it is detected that a trigger condition is met or a trigger indication is received, indication information is sent to a non-anchor network device.

In the embodiment of the present disclosure, the indication information may indicate the non-anchor network device to start PRACH reception.

In specific implementation, the non-anchor network device may be a network device corresponding to a non-anchor cell or a non-anchor carrier, and an anchor network device may be a network device corresponding to an anchor cell or an anchor carrier. Generally, the anchor carrier or the anchor cell can provide a wide coverage range, the non-anchor carrier or the non-anchor cell can provide high-speed data transmission, and a coverage area of the non-anchor carrier or the non-anchor cell is generally smaller than a coverage area of the anchor carrier or the anchor cell. The coverage area of the non-anchor carrier or the non-anchor cell may be within the coverage area of the anchor carrier or the anchor cell.

In the embodiment of the present disclosure, the terminal device satisfies the trigger condition, which may mean that N consecutive random access failures by the terminal device over the anchor carrier, where N≥2. In other words, when multiple random access by the terminal device fail consecutively over the anchor carrier, it can be determined that the terminal device satisfies the trigger condition. After detecting that the trigger condition is met, the terminal device may send indication information to the non-anchor network device.

In the embodiment of the present disclosure, the trigger indication may indicate the terminal device to send the indication information to the non-anchor network device. The trigger indication may also indicate the terminal device to perform random access through a non-anchor carrier.

In specific implementation, the trigger indication may be carried in a paging message, and the terminal device may determine that the trigger indication is received after receiving the paging message carrying the trigger indication over the anchor carrier. After receiving the trigger indication, the terminal device may also send the indication information to the non-anchor network device.

In specific implementation, the trigger indication may also be carried in paging downlink control information (DCI). The terminal device receives the paging DCI over the anchor carrier, and obtains the trigger indication from the paging DCI.

Specifically, in the paging DCI, a dedicated bit field may be set, and the trigger indication is represented by a value of the dedicated bit field, and the length of the dedicated bit field may be 1 bit.

For example, when the terminal device receives the paging DCI and detects that the value of the dedicated bit field in the paging DCI is 1, the terminal device determines that the trigger indication is received.

In specific implementation, the trigger indication may also be carried in a paging early indication (paging massage), and the terminal device receives the paging massage over the anchor carrier and obtains the trigger indication from the paging massage.

Specifically, in the paging massage, a dedicated bit field may be set, and the trigger indication is represented by a value of the dedicated bit field, and the length of the dedicated bit field may be 1 bit.

For example, when the terminal device receives the paging message and detects that the value of the dedicated bit field in the paging message is 1, the terminal device determines that the trigger indication is received.

It can be understood that, in the above embodiments, the length of the dedicated bit field in the paging DCI or the paging message may also be 2 bits or more. The length of the dedicated bit field is set as 1 bit, which can save downlink overhead and improve resource utilization efficiency.

Accordingly, the value of the dedicated bit field for indicating existence of the trigger indication may also be another value, for example, if the length of the dedicated bit field is 1 bit, the value of the dedicated bit field may also be set to 0 to indicate existence of the trigger indication.

In specific implementation, the indication information sent by the terminal device to the non-anchor network device may be carried by a first random access preamble. In other words, the indication information sent by the terminal device to the non-anchor network device may be represented by the first random access preamble. When the non-anchor network device receives the first random access preamble, the non-anchor network device determines that the indication information is received.

In the embodiment of the present disclosure, the first random access preamble may be implemented as one or more first random access preambles, and the terminal device may send the first random access preamble to the non-anchor network device by using a first random access occasion (RO) configured over a non-anchor carrier.

In the embodiment of the present disclosure, the first random access occasion may be any random access occasion for sending the random access request message. That is to say, any random access occasion for sending the random access request message may serve as the first random access occasion to carry the indication information used for sending the indication information to the non-anchor network device.

In practical applications, it can be understood that the random access preamble can be used for random access. In the embodiment of the present disclosure, the first random access preamble carries the indication information, that can only be used for indicating the non-anchor network device to start PRACH.

In the embodiment of the present disclosure, the anchor network device (i. e. the network device corresponding to the anchor cell) may configure one or more first random access preambles for the terminal device. The anchor network device may send a system message to the terminal device, and the system message carries configured configuration information of the first random access preamble. The anchor network device may send the system message to the terminal device over the anchor carrier.

The terminal device can receive the system message sent by the anchor network device over the anchor carrier, and obtains the configuration information of the one or more first random access preambles configured by the anchor network device from the system message.

In specific implementation, the configuration information of the first random access preamble may include an index address range of the first random access preamble. Alternatively, the configuration information of the first random access preamble may include a set of index numbers of the first random access preamble.

It can be seen that the configuration information of the first random access preamble can essentially be used for indicating which random access preambles are the first random access preambles.

For example, the configuration information of the first random access preamble includes the set of index numbers {1,2}, and then random access preamble 1 and random access preamble 2 are determined to be the first random access preamble.

In specific implementation, the anchor network device may select the first random access preamble from a contention random access preamble subset, and may also select the first random access preamble from a non-contention random access preamble subset.

The anchor network device may randomly select the first random access preamble from the contention random access preamble subset or the non-contention random access preamble subset, and may also select the first random access preamble from the contention random access preamble subset or the non-contention random access preamble subset according to a pre-set selection rule.

For example, the anchor network device randomly selects two random access preambles from the contention random access preamble subsets, which are respectively random access preamble 1 and random access preamble 3, and random access preamble 1 and random access preamble 3 serve as the first random access preamble.

For another example, the anchor network device selects two random access preambles from the non-contention random access preamble subset according to the pre-set rule, which are respectively random access preamble 2 and random access preamble 4, and then random access preamble 2 and random access preamble 4 serve as the first random access preamble.

In specific implementation, the terminal device may also send the indication information to the non-anchor network device on the periodic uplink resource. The anchor network device can configure configuration information of the periodic uplink resource for the terminal device over the non-anchor carrier, and send the configuration information of the periodic uplink resource over the non-anchor carrier to the terminal device through the system message. The anchor network device can send the system message to the terminal device over the anchor carrier, and the terminal device receives the system message over the anchor carrier, so as to obtain the configuration information of the periodic uplink resource over the non-anchor carrier, thereby determining the periodic uplink resource.

In the embodiment of the present disclosure, the periodic uplink resource over the non-anchor carrier may include a second random access occasion. In this case, the configuration information of the periodic uplink resource is configuration information of the second random access occasion.

The second random access occasion is used for sending the indication information, and the second random access occasion is a part of random access occasions used for sending the random access request message.

It can be seen that the first random access occasion is different from the second random access occasion in the embodiment of the present disclosure. The first random access occasion may be any random access occasion used for sending the random access request message, and the second random access occasion may be a part of the random access occasions used for sending the random access request message.

In the embodiments of the present disclosure, the indication information may be carried in a second random access preamble, and the second random access preamble may be any random access preamble used for the random access request, or the indication information may be carried in other types of sequences.

In the embodiment of the present disclosure, for an RO, the configuration information of the RO may include a period of the RO, the number of ROs in the time domain within one PRACH period, the number of ROs multiplexed in the frequency domain (Msg1-FDM), and a synchronization signal block associated with the RO (ssb-perRACH-occasion).

When the terminal device detects that the trigger condition is met or the trigger indication is received, the terminal device may send the indication information to the non-anchor network device by using the second random access occasion. After receiving the second random access preamble carried in the second random access occasion, the non-anchor network device starts PRACH reception.

In conclusion, in the embodiment of the present disclosure, the indication information may be carried in the first random access preamble. After receiving the first random access preamble, the non-anchor network device starts PRACH reception. The indication information may also be carried in the second random access preamble sent in the second random access occasion. After receiving the second random access preamble sent in the second random access occasion, the non-anchor network device starts PRACH reception.

At 102, a random access request message is sent to the non-anchor network device.

In specific implementation, after sending the indication information to the non-anchor network device by using the non-anchor carrier, the terminal device may send the random access request message (i. e. Msg1) by using a random access resource configured over the non-anchor carrier and used for sending the random access request message.

In the embodiment of the present disclosure, the random access resource used for sending the random access request message can include a random access preamble and a random access occasion used for sending the random access request. Here, the random access preamble used for sending the random access request message may be different from the first access preamble, and the random access occasion for sending the random access request may be different from the second random access occasion.

In the embodiment of the present disclosure, after using the non-anchor carrier to send the indication information to the non-anchor network device, the terminal device may send, with a delay of X time units, Msg1 by using an RO configured over the non-anchor carrier and used for sending the random access request message. The unit of the time unit may be a symbol, a slot, or an ms. The value of x may be configured by a network, or preset in a protocol.

In specific implementation, after receiving the indication information, the non-anchor network device starts PRACH reception. It may take a period of time for the non-anchor network device to start PRACH reception, and the non-anchor network device does not receive any random access request message sent by the terminal device during the period. If the terminal device sends the random access request message immediately after sending the indication information, the random access request message sent by the terminal device will not be received by the non-anchor network device, resulting in a waste of power consumption.

By sending the random access request message with the delay of X time units, it is ensured that the non-anchor network device can receive the random access request message sent by the terminal device, thereby avoiding a waste of power consumption of the terminal device.

In conclusion, in the embodiment of the present disclosure, when it is detected that a trigger condition is satisfied or a trigger indication is received, the terminal device sends the indication information to the non-anchor network device. After receiving the indication information, the non-anchor network device starts PRACH reception, and then the terminal device sends the random access request message to the non-anchor network device, so as to access the non-anchor network device.

Compared with the related art, the technical solutions of the embodiments of the present disclosure have the following beneficial effects. When it is detected that the trigger condition is met or the trigger indication is received, the terminal device sends indication information to the non-anchor network device. After receiving the indication information, the non-anchor network device starts PRACH reception, and then the terminal device sends the random access request message to the non-anchor network device, so as to access the non-anchor network device. Since the non-anchor network device does not start PRACH reception until receiving the trigger information, the power consumption of the non-anchor network device can be reduced effectively.

Referring to FIG. 3, another random access method according to an embodiment of the present disclosure is provided, which will be described in detail through specific operations.

In the embodiment of the present disclosure, the random access method corresponding to operations at 301 and 302 may be executed by a chip capable of processing data in a non-anchor network device, or executed by a chip module that includes the chip capable of processing data in the non-anchor network device. For illustrative purpose, the non-anchor network device is an execution body in the below.

At 301, PRACH reception is started in response to indication information being received.

In specific implementation, when detecting that a trigger condition is met or a trigger indication is received, the terminal device may send the indication information to the non-anchor network device.

In the embodiment of the present disclosure, the terminal device satisfies the trigger condition, which may mean that N consecutive random access failures by the terminal device over the anchor carrier, where N≥2. In other words, when multiple consecutive random access by the terminal device fail consecutively over the anchor carrier, it can be determined that the terminal device satisfies the trigger condition. After detecting that the trigger condition is met, the terminal device may send indication information to the non-anchor network device.

In the embodiment of the present disclosure, the trigger indication may indicate the terminal device to send the indication information to the non-anchor network device. The trigger indication may also indicate the terminal device to perform random access through a non-anchor carrier.

In specific implementation, the trigger indication may be carried in a paging message, and the terminal device may determine that the trigger indication is received after receiving the paging message carrying the trigger indication over the anchor carrier. After receiving the trigger indication, the terminal device may also send the indication information to the non-anchor network device.

In specific implementation, the trigger indication may also be carried in paging DCI. The terminal device receives the paging DCI over the anchor carrier, and obtains the trigger indication from the paging DCI.

Specifically, in the paging DCI, a dedicated bit field may be set, and the trigger indication is represented by a value of the dedicated bit field, and the length of the dedicated bit field may be 1 bit.

For example, when the terminal device receives the paging DCI and detects that the value of the dedicated bit field in the paging DCI is 1, the terminal device determines that the trigger indication is received.

In specific implementation, the trigger indication may also be carried in a paging early indication (paging massage), and the terminal device receives the paging massage over the anchor carrier and obtains the trigger indication from the paging massage.

Specifically, in the paging massage, a dedicated bit field may be set, and the trigger indication is represented by a value of the dedicated bit field, and the length of the dedicated bit field may be 1 bit.

For example, when the terminal device receives the paging message and detects that the value of the dedicated bit field in the paging message is 1, the terminal device determines that the trigger indication is received.

In specific implementation, the indication information sent by the terminal device to the non-anchor network device may be carried by a first random access preamble. In other words, the indication information sent by the terminal device to the non-anchor network device may be represented by the first random access preamble. When the non-anchor network device receives the first random access preamble, the non-anchor network device determines that the indication information is received.

The first random access preamble may be implemented as one or more first random access preambles, and the terminal device may send the first random access preamble to the non-anchor network device by using a first random access occasion (RO) configured over a non-anchor carrier.

In the embodiment of the present disclosure, the first random access occasion may be any random access occasion for sending the random access request message. That is to say, any random access occasion for sending the random access request message may serve as the first random access occasion to carry the indication information used for sending the indication information to the non-anchor network device.

In the embodiment of the present disclosure, the anchor network device (i. e. the network device corresponding to the anchor cell) may configure one or more first random access preambles for the terminal device. The anchor network device may send a system message to the terminal device, and the system message carries configured configuration information of the first random access preamble. The anchor network device may send the system message to the terminal device over the anchor carrier.

The terminal device can receive the system message sent by the anchor network device over the anchor carrier, and obtains the configuration information of the one or more first random access preambles configured by the anchor network device from the system message.

In specific implementation, the configuration information of the first random access preamble may include an index address range of the first random access preamble. Alternatively, the configuration information of the first random access preamble may include a set of index numbers of the first random access preamble.

It can be seen that the configuration information of the first random access preamble can essentially be used for indicating which random access preambles are the first random access preambles.

For example, the configuration information of the first random access preamble includes the set of index numbers {1,2}, and then random access preamble 1 and random access preamble 2 are determined to be the first random access preamble.

In specific implementation, the anchor network device may select the first random access preamble from a contention random access preamble subset, and may also select the first random access preamble from a non-contention random access preamble subset.

The anchor network device may randomly select the first random access preamble from the contention random access preamble subset or the non-contention random access preamble subset, and may also select the first random access preamble from the contention random access preamble subset or the non-contention random access preamble subset according to a pre-set selection rule.

For example, the anchor network device randomly selects two random access preambles from the contention random access preamble subsets, which are respectively random access preamble 1 and random access preamble 3, and random access preamble 1 and random access preamble 3 serve as the first random access preamble.

For another example, the anchor network device selects two random access preambles from the non-contention random access preamble subset according to the pre-set rule, which are respectively random access preamble 2 and random access preamble 4, and then random access preamble 2 and random access preamble 4 serve as the first random access preamble.

In specific implementation, the terminal device may also send the indication information to the non-anchor network device on the periodic uplink resource. The anchor network device can configure configuration information of the periodic uplink resource for the terminal device over the non-anchor carrier, and send the configuration information of the periodic uplink resource over the non-anchor carrier to the terminal device through the system message. The anchor network device can send the system message to the terminal device over the anchor carrier, and the terminal device receives the system message over the anchor carrier, so as to obtain the configuration information of the periodic uplink resource over the non-anchor carrier, thereby determining the periodic uplink resource.

In the embodiment of the present disclosure, the periodic uplink resource over the non-anchor carrier may include a second random access occasion. In this case, the configuration information of the periodic uplink resource is configuration information of the second random access occasion.

The second random access occasion is used for sending the indication information, and the second random access occasion is a part of random access occasions used for sending the random access request message.

It can be seen that the first random access occasion is different from the second random access occasion in the embodiment of the present disclosure. The first random access occasion may be any random access occasion used for sending the random access request message, and the second random access occasion may be a part of the random access occasions used for sending the random access request message.

In the embodiments of the present disclosure, the indication information may be carried in a second random access preamble, and the second random access preamble may be any random access preamble used for the random access request, or the indication information may be carried in other types of sequences.

In the embodiment of the present disclosure, for an RO, the configuration information of the RO may include a period of the RO, the number of ROs in the time domain within one PRACH period, the number of ROs multiplexed in the frequency domain (Msg1-FDM), and a synchronization signal block associated with the RO (ssb-perRACH-occasion).

When the terminal device detects that the trigger condition is met or the trigger indication is received, the terminal device may send the indication information to the non-anchor network device by using the second random access occasion. After receiving the second random access preamble carried in the second random access occasion, the non-anchor network device starts RACH reception.

In other words, the indication information is essentially represented by the second random access occasion. Specifically, the second random access occasion is RO1 and RO2, and when the non-anchor network device detects that the random access occasion for sending the random access preamble includes RO1 and RO2, the non-anchor network device determines that the indication information is received, and then the non-anchor network device starts PRACH reception.

That is to say, if the terminal device reports the random access preamble on RO1 and RO2, it means that the terminal device sends the indication information to the non-anchor network device.

At 302, a random access request message is received.

In specific implementation, after sending the indication information to the non-anchor network device by using the non-anchor carrier, the terminal device may send the random access request message (i. e. Msg1) by using a random access resource configured over the non-anchor carrier and used for sending the random access request message.

In the embodiment of the present disclosure, the random access resource used for sending the random access request message can include a random access preamble and a random access occasion used for sending the random access request. Here, the random access preamble used for sending the random access request message may be different from the first access preamble, and the random access occasion for sending the random access request may be different from the second random access occasion.

In the embodiment of the present disclosure, after using the non-anchor carrier to send the indication information to the non-anchor network device, the terminal device may send, with a delay of X time units, Msg1 by using an RO configured over the non-anchor carrier and used for sending the random access request message. The unit of the time unit may be a symbol, a slot, or an ms. The value of x may be configured by a network, or preset in a protocol.

In specific implementation, after receiving the indication information, the non-anchor network device starts PRACH reception. It may take a period of time for the non-anchor network device to start PRACH reception, and the non-anchor network device does not receive any random access request message sent by the terminal device during the period. If the terminal device sends the random access request message immediately after sending the indication information, the random access request message sent by the terminal device will not be received by the non-anchor network device, resulting in a waste of power consumption.

In the embodiment of the present disclosure, by sending the random access request message with the delay of X time units, it is ensured that the non-anchor network device can receive the random access request message sent by the terminal device, thereby avoiding a waste of power consumption of the terminal device.

Referring to FIG. 4, a random access apparatus 40 is provided in the embodiment of the present disclosure. The random access apparatus 40 includes a first sending unit 401 and a second sending unit 402.

The first sending unit 401 is configured to send indication information to a non-anchor network device in response to detecting that a trigger condition being satisfied or a trigger indication being received; where the indication information indicates that the non-anchor network device starts physical random access channel (PRACH) reception.

The second sending unit 402 is configured to send a random access request message to the non-anchor network device.

In specific implementation, for a specific implementation process of the first sending unit 401 and the second sending unit 402, reference may be made to operations at 101 and 102, and details are not described herein again.

In specific implementation, the random access apparatus 40 may correspond to a chip having a data processing function in a terminal device; or a chip module including the chip with a data processing function in a terminal device, or a terminal device.

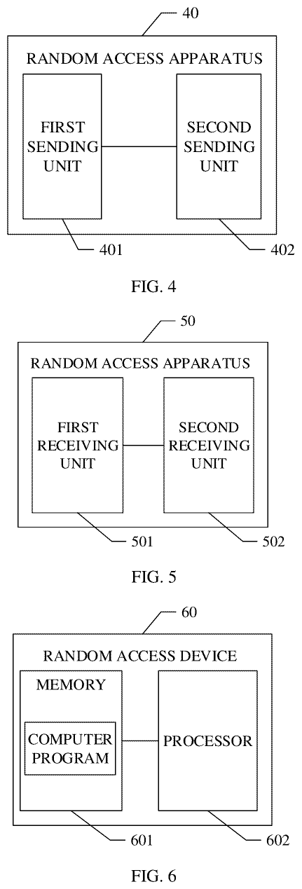

Referring to FIG. 5, another random access apparatus 50 is provided in the embodiment of the present disclosure. The random access apparatus 50 includes a first receiving unit 501 and a second receiving unit 502.

The first receiving unit 501 is configured to start PRACH reception in response to indication information being received.

The second receiving unit 502 is configured to receive a random access request message.

In specific implementation, for a specific implementation process of the first receiving unit 501 and the receiving sending unit 502, reference may be made to operations at 301 and 302, and details are not described herein again.

In specific implementation, the random access apparatus 50 may correspond to a chip having a data processing function in a network device; or a chip module including the chip with a data processing function in a network device, or a network device.

In specific implementation, each module/unit in the apparatus or product may be a software module/unit, a hardware module/unit, or may be partially a software module/unit and partially a hardware module/unit.

For example, for each device and product applied to or integrated into the chip, each module/unit included can be implemented by hardware such as circuits, or at least part of modules/units can be implemented by software programs that run on a processor integrated into the chip, and the rest of modules/units (if any) can be implemented by hardware such as circuits. For each device and product applied to or integrated into the chip module, each module/unit included can be implemented by hardware such as circuit, and different modules/units can be located in the same component (such as a chip, a circuit module, etc.) or different components of the chip module. Alternatively, at least part of modules/units can be implemented by software programs that run on the processor integrated into the chip module, and the rest of modules/units (if any) can be implemented by hardware such as circuits. For each device and product applied to or integrated into the UE, each module/unit included can be implemented by hardware such as circuits, and different modules/units can be located in a same component (e.g., a chip, a circuit module, etc.) or different components in the terminal device, or at least part of modules/units can be implemented by software programs that run on the processor integrated into the UE, and the rest of modules/units (if any) can be implemented by hardware such as circuits.

Embodiments of the present disclosure further provide a computer-readable storage medium. The computer-readable storage medium is a non-volatile storage medium or a non-transitory storage medium, the computer-readable storage medium is configured to store a computer program which, when executed by a processor, causes the processor to perform the random access method at 101 and 102, or causes the processor to perform the random access method at 301 and 302.

As illustrated in FIG. 6, embodiments of the present disclosure further provide a random access device 60. The random access device 60 includes a memory 601 and a processor 602. The memory 601 is configured to store a computer program executable on the processor 602, and the processor 602 is configured to execute the computer program to perform the random access method at 101 and 102 or perform the random access method at 301 and 302.

A person of ordinary skill in the art may understand that all or part of steps of the methods according to the embodiments of the present disclosure may be accomplished by means of a program to instruct associated hardware, and the program may be stored in a computer-readable memory, which may include a read-only memory (ROM), a random access memory (RAM), a magnetic disk, or an optical disk.

Although the present disclosure has been described above, the present disclosure is not limited thereto, and various changes and modifications can be made by those skilled in the art without departing from the spirit and scope of the present disclosure. Therefore, the scope of the present disclosure should be defined by the appended claims.

1. A random access method applied to a terminal device, comprising:
in response to detecting that a trigger condition being satisfied or a trigger indication being received, sending indication information to a non-anchor network device; wherein the indication information indicates that the non-anchor network device starts physical random access channel (PRACH) reception; and
sending a random access request message to the non-anchor network device.

2. The random access method of claim 1, wherein sending the indication information to the non-anchor network device comprises:
sending a first random access preamble to the non-anchor network device, wherein the first random access preamble carries the indication information.

3. The random access method of claim 2, wherein sending the first random access preamble to the non-anchor network device comprises:
sending the first random access preamble to the non-anchor network device by using a first random access occasion configured over a non-anchor carrier, wherein the first random access occasion is any random access occasion for sending the random access request message.

4. The random access method of claim 2, wherein before sending the first random access preamble to the non-anchor network device, the method further comprises:
obtaining a system message sent by an anchor network device; and
obtaining configuration information of the first random access preamble from the system message.

5. The random access method of claim 4, wherein the configuration information of the first random access preamble comprises: an index range of the first random access preamble, or a set of index numbers of the first random access preamble.

6. The random access method of claim 4, wherein obtaining the system message sent by the anchor network device comprises:
receiving, over an anchor carrier, the system message sent by the anchor network device.

7. The random access method of claim 1, wherein sending the indication information to the non-anchor network device comprises:
sending the indication information to the non-anchor network device by using a periodic uplink resource, wherein the periodic uplink resource is configured by an anchor network device for a non-anchor carrier.

8. The random access method of claim 7, wherein before sending the indication information to the non-anchor network device by using the periodic uplink resource, the method further comprises:
obtaining a system message sent by an anchor network device; and
obtaining configuration information of the periodic uplink resource from the system message.

9. The random access method of claim 8, wherein
the configuration information of the periodic uplink resource is configuration information of a second random access occasion; the second random access occasion is used for sending the indication information; and the second random access occasion is a part of random access occasions used for sending the random access request message.

10. The random access method of claim 9, wherein sending the indication information to the non-anchor network device by using the periodic uplink resource comprises:
sending a second random access preamble by using the second random access occasion, wherein the indication information is carried in the second random access preamble, and the second random access preamble is any random access preamble.

11. The random access method of claim 1, wherein the trigger condition comprises:
N consecutive random access failures over the anchor carrier.

12. The random access method of claim 1, wherein the trigger indication being received comprises:
obtaining the trigger indication by receiving paging downlink control information (DCI); or,
obtaining the trigger indication by receiving a paging early indication; or,
obtaining the trigger indication by receiving a paging message.

13. The random access method of claim 1, wherein sending the random access request message to the non-anchor network device comprises:
sending the random access request message by using a random access resource used for sending the random access request message.

14. The random access method of claim 13, wherein sending the random access request message comprises:
sending the random access request message with a delay of X time units after sending the indication information to the non-anchor network device.

15. A random access method applied to a non-anchor network device, comprising:
starting physical random access channel (PRACH) reception in response to indication information being received; and
receiving a random access request message.

16. The random access method of claim 15, wherein starting the PRACH reception in response to the indication information being received comprises:
starting the PRACH reception in response to a first random access preamble being received, wherein the first random access preamble carries the indication information.

17. The random access method of claim 16, wherein the first random access preamble is sent by a terminal device in a first random access occasion configured over a non-anchor carrier, wherein the first random access occasion is any random access occasion for sending the random access request message.

18. The random access method of claim 15, wherein starting the PRACH reception in response to the indication information being received comprises:
receiving the indication information on a periodic uplink resource, wherein the periodic uplink resource is configured by an anchor network device for the non-anchor carrier.

19. The random access method of claim 18, wherein the indication information comprises a random access preamble.

20-23. (canceled)

24. A random access device, comprising a memory and a processor, wherein the memory is configured to store a computer program executable on the processor, and the processor is configured to execute the computer program to perform;
in response to detecting that a trigger condition being satisfied or a trigger indication being received, sending indication information to a non-anchor network device; wherein the indication information indicates that the non-anchor network device starts physical random access channel (PRACH) reception; and
sending a random access request message to the non-anchor network device.
